(19) United States
(12) Patent Application Publication
(10) Pub. No.: US 2016/0192162 A1
(43) Pub. Date: Jun. 30, 2016

(54) Method for Transferring Call on Mobile Terminal, and Mobile Terminal

(71) Applicant: ZTE CORPORATION, Guangdong (CN)

(72) Inventors: Lizhang LIU, Shenzhen (CN); Tao XUE, Shenzhen (CN)

(21) Appl. No.: 14/910,685

(22) PCT Filed: Apr. 4, 2014
(86) PCT No.: PCT/CN2014/074810

§ 371 Date: Feb. 6, 2016

(30) Foreign Application Priority Data
Aug. 15, 2013 (CN) 201310357257.8

(51) Int. Cl. H04W 4/16; H04W 76/06; H04W 76/02

(52) U.S. Cl. CPC H04W 4/16; H04W 76/02; H04W 76/06

(57) ABSTRACT

A method for transferring a call in a mobile terminal and a mobile terminal thereof, wherein the method includes: a mobile terminal controlling its two communication cards to respectively establish a first call connection and a second call connection; when receiving a call transferring instruction, the mobile terminal obtaining downlink channel data of the first call connection and the second call connection; the mobile terminal taking the obtained downlink channel data of the first call connection as uplink channel data of the second call connection, and taking the obtained downlink channel data of the second call connection as uplink call connection of the first call connection, and shielding an audio data input/output unit in the mobile terminal.

### TECHNICAL FIELD

The present document relates to the field of communication technologies, and more particularly, to a method for transferring a call on a mobile terminal and a mobile terminal thereof.

### BACKGROUND OF THE RELATED ART

Although a related dual-card dual-standby dual-pass mobile terminal can achieve a three-party call under two communication cards, when two parties want to talk directly during the call, they must hang up and then call each other directly to talk with each other directly. For example, Xiao Wang establishes a call connection with Xiao Hong via a first communication card, and also establishes a call connection with Xiao Ming via a second communication card, and if Xiao Hong and Xiao Ming want to chat with each other, they can only do so by respectively hanging up the call connections with Xiao Wang and redial each other's phone number to chat, and when the Xiao Hong and Xiao Ming don't hang up the call connections with Xiao Wang respectively, the call of the Xiao Hong and Xiao Ming cannot be directly transferred by Xiao Wang to implement the direct call between the Xiao Hong and Xiao Ming. Also, if Xiao Hong is looking for Xiao Ming through the first card, the terminal may directly dial Xiao Ming's phone number through the second card and directly transfer the call to Xiao Hong without disclosing the Xiao Ming's phone number or hanging up the call. With the increasing number of dual-card dual-standby dual-pass terminals, this call transferring function will become the urgent needs of the users.

### SUMMARY OF THE INVENTION

The embodiment of the present document is to provide a method for transferring a call on a mobile terminal and the mobile terminal thereof to address the defects that the call transferring function cannot be achieved in an existing mobile terminal.

The embodiment of the present document provides a method for transferring a call in a mobile terminal, comprising: a mobile terminal controlling its two communication cards to respectively establish a first call connection and a second call connection; when receiving a call transferring instruction, the mobile terminal obtaining downlink channel data of the first call connection and the second call connection;

the mobile terminal taking the obtained downlink channel data of the first call connection as uplink channel data of the second call connection, and taking the obtained downlink channel data of the second call connection as uplink channel data of the first call connection, and shielding an audio data input/output unit in the mobile terminal.

Preferably, before obtaining the downlink channel data of the first call connection and the second call connection, a call state corresponding to the first call connection is a call hold state, a call state corresponding to the second call connection is a call activated state.

Preferably, after the mobile terminal controls its two communication cards to respectively establish the first call connection and the second call connection, the method further comprises: upon receiving a call termination instruction sent by a user through the present terminal, the mobile terminal controlling its two communication cards to disconnect the established first call connection and second call connection; or when the first call connection is terminated, the mobile terminal controlling the second call connection to be disconnected, or when the second call connection is terminated, the mobile terminal controlling the first call connection to be disconnected.

A method for transferring a call in a mobile terminal, comprising: a mobile terminal controlling its first communication card to establish a first call connection; when receiving a call transferring instruction, the mobile terminal controlling its second communication card to establish a second call connection and obtaining downlink channel data of the first call connection and the second call connection; the mobile terminal taking the obtained downlink channel data of the first call connection as uplink data channel of the second call connection, and taking the obtained downlink channel data of the second call connection as the uplink channel data of the first call connection, and shielding an audio data input/output unit in the mobile terminal.

Preferably, before obtaining the downlink channel data of the first call connection and the second call connection, the call state corresponding to the first call connection and the call state corresponding to the second call connection are the call activated state.

Preferably, after controlling its second communication card to establish the second call connection, the method further comprises: upon receiving a call termination instruction sent by the user through the present terminal, the mobile terminal controlling its two communication cards to disconnect the established first call connection and second call connection; or the mobile terminal controlling the second call connection to be disconnected when the first call connection is terminated, or controlling the first call connection to be disconnected when the second call connection is terminated.

The embodiment of the present document further provides a mobile terminal for transferring a call in the mobile terminal, comprising:

a controlling module, configured to: control two communication cards of the mobile terminal to respectively establish a first call connection and a second call connection; an obtaining module, configured to: upon receiving a call transferring instruction, obtain downlink channel data of the first call connection and the second call connection; a processing module, configured to: take the obtained downlink channel data of the first call connection as uplink channel data of the second call connection, and take the obtained downlink channel data of the second call connection as uplink data channel of the first call connection, and shield an audio data input/output unit in the mobile terminal.

Preferably, the controlling module is further configured to: upon receiving a call termination instruction sent by the user through the present terminal, control two communication cards of the mobile terminal to disconnect the established first call connection and second call connection; or control the second call connection to be disconnected when the first call connection is terminated, or control the first call connection to be disconnected when the second call connection is terminated.

A mobile terminal for transferring a call in the mobile terminal, comprising: a controlling module, configured to: control first communication card of the mobile terminal to establish a first call connection, and further configured to: control second communication card of the mobile terminal to establish a second call connection upon receiving a call transferring instruction; an obtaining module, configured to: obtain downlink channel data of the first call connection and the second call connection; a processing module, configured to: take the obtained downlink channel data of the first call connection as uplink channel data of the second call connection, and take the obtained downlink channel data of the second call connection as uplink data channel of the first call connection, and shield the audio data input/output unit in the mobile terminal.

Preferably, the controlling module is further configured to: upon receiving a call termination instruction sent by a user through the present terminal, control two communication cards of the mobile terminal to disconnect the established first call connection and second call connection; or

control the second call connection to be disconnected when the first call connection is terminated, or control the first call connection to be disconnected when the second call connection is terminated.

The embodiment of the present document can directly perform a call connection on the opposite-end calls through a call transferring method without hanging up the current call connections when two communication cards respectively establish call connections according to user demands, so as to easily, simply and quickly implement the call transferring function in a mobile terminal.

### BRIEF DESCRIPTION OF THE DRAWINGS

FIG. 1 is a flow chart of an embodiment of a method for transferring a call in a mobile terminal in accordance with an embodiment of the present document;

FIG. 2 is a flow chart of another embodiment of the method for transferring a call in a mobile terminal in accordance with an embodiment of the present document;

FIG. 3 is a functional block diagram of an embodiment of a mobile terminal for transferring a call in a mobile terminal in accordance with an embodiment of the present document;

FIG. 4 is a functional block diagram of another embodiment of the mobile terminal for transferring a call in a mobile terminal in accordance with an embodiment of the present document.

### PREFERRED EMBODIMENTS OF THE INVENTION

Hereinafter, in conjunction with the accompanying drawings and embodiments, the technical solution of the present document will be further described. It should be understood that the specific embodiments described herein are only intended to explain rather than limit the present document.

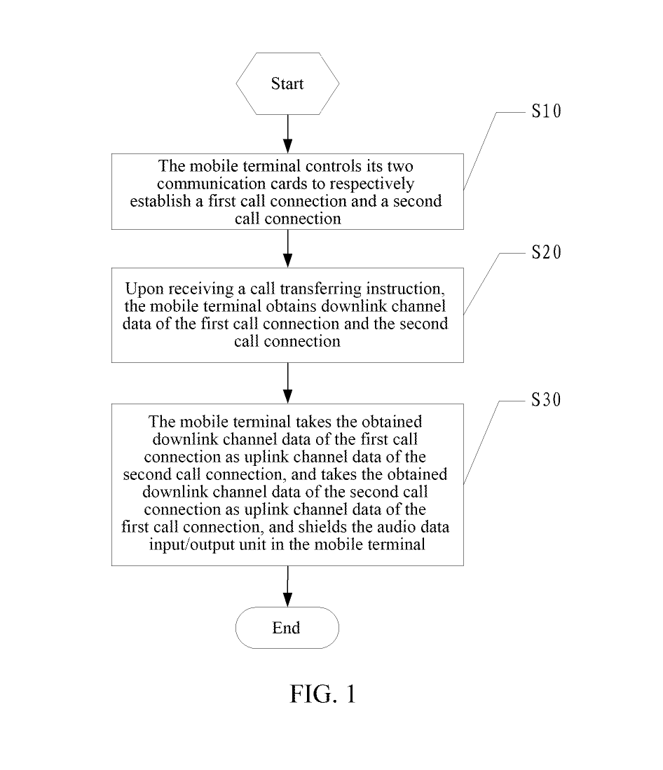

FIG. 1 shows a flow chart of an embodiment of the method for transferring a call in a mobile terminal in accordance with an embodiment of the present document.

It should be emphasized that: the flow chart shown in FIG. 1 is only a preferred embodiment, and those skilled in the art should know that any embodiments constructed within the thoughts of the present document should not be departed from the scope covered in the following technical solution:

the method for transferring a call in a mobile terminal provided in the present embodiment comprises:

in step S10, the mobile terminal controls its two communication cards to respectively establish a first call connection and a second call connection;

In the present embodiment, the two communication cards may belong to the same network standard, which can be any one of GSM (Global System Of Mobile Communication), WCDMA (Wideband Code Division Multiple Access), CDMA (Code division Multiple Access), TD-SCDMA (Time division-synchronous Code division Multiple Access) and LTE (long Term Evolution), or may respectively belong to any two of the GSM, the CDMA, the WCDMA, the TD-SCDMA and the LTE. For example, the mobile terminal establishes a first call connection through the GSM network standard of the first communication card and establishes a second call connection through the CDMA network standard of the second communication card, or the mobile terminal establishes a first call connection through the GSM network standard of the first communication card, and establishes a second call connection through the GSM network standard of the second communication card.

In step S20, upon receiving a call transferring instruction, the mobile terminal obtains downlink channel data of the first call connection and the second call connection;

upon receiving the call transferring instruction, the mobile terminal has already established two call connections through the two communication cards. The call state corresponding to the first call connection is the call hold state, that is, call waiting state, the call state corresponding to the second call connection is the call activated state, that is, normal call state. According to the user needs, it may also switch between these two states. For example, when the user wants to switch from the call of the second call connection to the first call connection, it transmits a Retrieve instruction to the network side of the first communication card and transmits a Hold instruction to the network side of the second communication card, to retrieve the first call connection of the first communication card; of course, the user can also switch the call of the first call connection to the second call connection, the processing procedure is the same and is not repeated here.

After receiving the call transferring instruction, it sends a Retrieve instruction to the corresponding first communication card or second communication card to enable the first communication card or the second communication card to stay in the call activated state, that is, the normal call state. The mobile terminal obtains the downlink channel data of the first call connection established through the first communication card and the downlink channel data of the second call connection established through the second communication card.

In step S30, the mobile terminal takes the obtained downlink channel data of the first call connection as the uplink channel data of the second call connection, and takes the obtained downlink channel data of the second call connection as the uplink channel data of the first call connection, and shields the audio data input/output unit in the mobile terminal.

In the GSM and CDMA network standards, for example, the mobile terminal controls its two communication cards to establish the first call connection and the second call connection respectively through the GSM and CDMA networks, upon receiving a call transferring instruction, the mobile terminal takes the downlink channel data received from the GSM network side as uplink channel data of the CDMA network side to transmit, and takes the downlink channel data received from the CDMA network side as uplink channel data of the GSM network side to transmit.

The audio data input/output unit is in the shielded state, that is, it does not perform any data processing, which well protects the privacy of the opposite-end of call transferring. The audio data input/output unit comprises: Mic (Microphone), Receiver, Speaker and other audio data input/output units with the same function.

Preferably, in the call transferring process, when the mobile terminal receives a call termination instruction sent by the user through the present terminal, the mobile terminal controls the first communication card and the second communication card to disconnect the established first call connection and second call connection; or the mobile terminal controls the second call connection of the second communication card to be disconnected when the first call connection of the first communication card is terminated, or the mobile terminal controls the first call connection of the first communication card to be disconnected when the second call connection is terminated.

In order to facilitate the implementation of the call transferring in the dual-card single-network mode or the dual-card dual-network mode, two sets of baseband radio frequency provided in the embodiment of the present document can process the uplink channel data of the calls respectively established through two communication cards without performing any changes to the network side.

The present embodiment can directly perform a call connection on the opposite-end calls through a call transferring method without hanging up the current call connections when two communication cards respectively establish call connections according to user demands, so as to easily, simply and quickly implement the call transferring function in a mobile terminal.

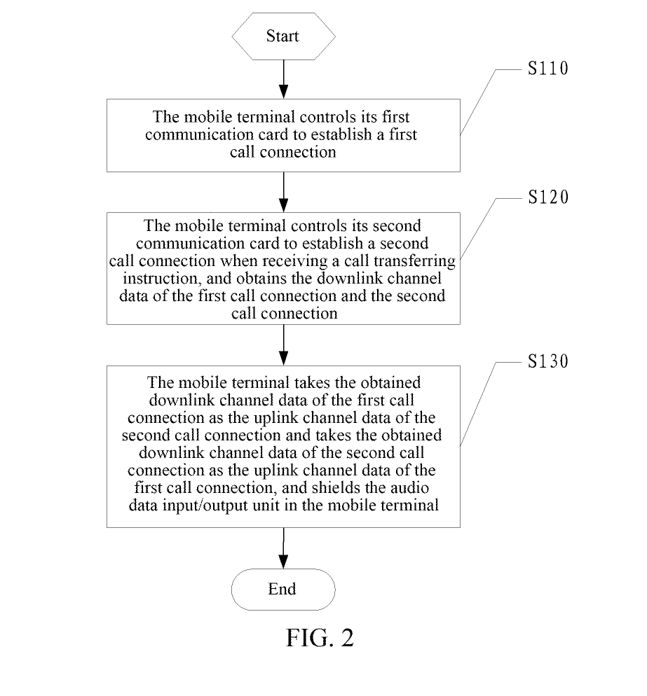

FIG. 2 shows a flow chart of another embodiment of the method for transferring a call in a mobile terminal in accordance with an embodiment of the present document.

It should be emphasized that: the flow chart shown in FIG. 2 is only a preferred embodiment, and those skilled in the art should know that any embodiments constructed within the thoughts of the present document should not be departed from the scope covered in the following technical solution:

The method for transferring a call in a mobile terminal provided in the present embodiment comprises:

in step S110, the mobile terminal controls its first communication card to establish a first call connection;

in step S120, the mobile terminal controls its second communication card to establish a second call connection when receiving a call transferring instruction, and obtains the downlink channel data of the first call connection and the second call connection;

in the present embodiment, the first communication card and the second communication card may belong to the same network standard, which can be any one of GSM (Global System Of Mobile Communication), WCDMA (Wideband Code Division Multiple Access), CDMA (Code division Multiple Access), TD-SCDMA (Time division-synchronous Code division Multiple Access) and LTE (long Term Evolution), or respectively belong to any two of the GSM, the CDMA, the WCDMA, the TD-SCDMA and the LTE. For example, the mobile terminal establishes a first call connection through the GSM network standard of the first communication card and the mobile terminal establishes a second call connection through the CDMA network standard of the second communication card when receiving a call transferring instruction, or the mobile terminal establishes a first call connection through the GSM network standard of the first communication card, and the mobile terminal establishes a second call connection through the GSM network standard of the second communication card when receiving a call transferring instruction.

The mobile terminal controls its first communication card to establish a first call connection; upon receiving the call transferring instruction, the mobile terminal controls its second communication card to establish a second call connection. In this case the mobile terminal has already established two call connections through the first communication card and the second communication card respectively. The call state corresponding to the first call connection and the call state corresponding to the second call connection are the call activated state, that is, the normal call state.

When the mobile terminal controls its second communication card to establish the second call connection, the mobile terminal obtains the downlink channel data of the first call connection established through the first communication card as well as the downlink channel data of the second call connection established through the second communication card.

In step S130, the mobile terminal takes the obtained downlink channel data of the first call connection as the uplink channel data of the second call connection and the obtained downlink channel data of the second call connection as the uplink channel data of the first call connection, and shields the audio data input/output unit in the mobile terminal.

In the GSM and CDMA network standards, for example, the mobile terminal controls its first communication card to establish the first call connection through the GSM network, and controls its second communication card to establish the second call connection through the CDMA network when receiving a call transferring instruction, and it obtains the downlink channel data of the first call connection established through the first communication card and the downlink channel data of the second call connection established through the second communication card; the mobile terminal takes the downlink channel data received from the GSM network side as uplink channel data of the CDMA network side to transmit, and takes the downlink channel data received from the CDMA network side as uplink channel data of the GSM network side to transmit.

The audio data input/output unit is in the shielded state, that is, it does not perform any data processing, which well protects the privacy of the opposite-end of call transferring. The audio data input/output unit comprises: Mic (Microphone), Receiver, Speaker and other audio data input/output units with the same function.

Furthermore, in the call transferring process, when the mobile terminal receives a call termination instruction sent by the user through the present terminal, the mobile terminal controls the first communication card and the second communication card to disconnect the established first call connection and second call connection; or the mobile terminal controls the second call connection of the second communication card to be disconnected when the first call connection of the first communication card is terminated, or the mobile terminal controls the first call connection of the first communication card to be disconnected when the second call connection is terminated.

In order to facilitate the implementation of the call transferring in the dual-card single-network mode or the dual-card dual-network mode, two sets of baseband radio frequency provided in the embodiment of the present document can process the uplink channel data of the calls respectively established through two communication cards without performing any changes to the network side.

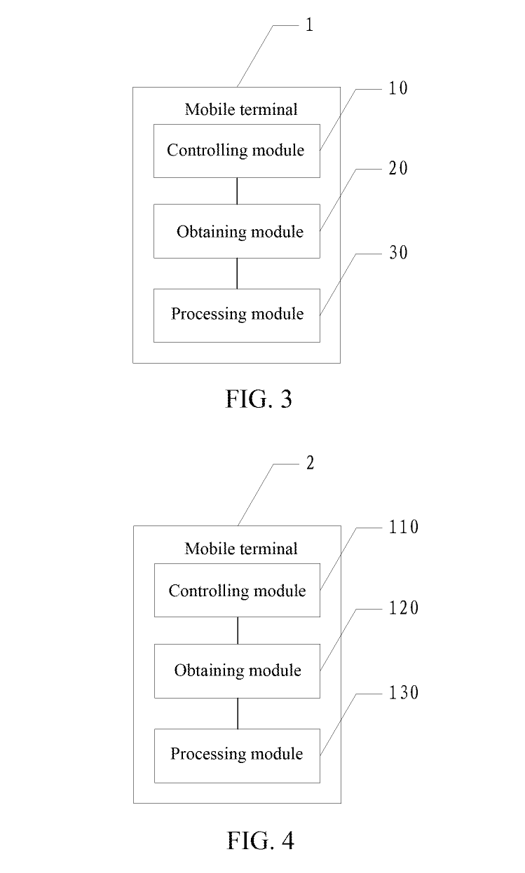

FIG. 3 shows a functional block diagram of an embodiment of the mobile terminal for transferring a call in a mobile terminal in accordance with the present document. The mobile terminal 1 provided in the present embodiment comprises:

a controlling module 10, used to control two communication cards of the mobile terminal to respectively establish a first call connection and a second call connection;

In the present embodiment, the two communication cards may belong to the same network standard, which can be any one of GSM, WCDMA, CDMA, TD-SCDMA and LTE, or respectively belong to any two of the GSM, the CDMA, the WCDMA, the TD-SCDMA and the LTE. For example, the controlling module 10 establishes a first call connection through the GSM network standard of the first communication card and establishes a second call connection through the CDMA network standard of the second communication card, or the controlling module 10 establishes the first call connection through the GSM network standard of the first communication card, and establishes the second call connection through the GSM network standard of the second communication card.

An obtaining module 20 is configured to, upon receiving a call transferring instruction, obtain downlink channel data of the first call connection and the second call connection;

upon receiving the call transferring instruction, the controlling module 10 has already established two call connections through the two communication cards. The call state corresponding to the first call connection is the call hold state, that is, the call waiting state, and the call state corresponding to the second call connection is the call activated state, that is, the normal call state. According to the user needs, it can also switch between these two states. For example, when the user wants to switch from the call of the second call connection to the first call connection, it transmits a Retrieve instruction to the network side of the first communication card and transmits a Hold instruction to the network side of the second communication card to retrieve the first call connection of the first communication card; of course, the user can also switch the call of the first call connection to the second call connection, the processing procedure is same and is not repeated here.

After receiving the call transferring instruction, it is to send a Retrieve instruction to the corresponding first communication card or second communication card to enable the first communication card or second communication card to stay in the call activated state, that is the normal call state. The obtaining module 20 obtains the downlink channel data of the first call connection established through the first communication card and the downlink channel data of the second call connection established through the second communication card.

A processing module 30 is configured to: take the obtained downlink channel data of the first call connection as uplink channel data of the second call connection and the obtained downlink channel data of the second call connection as uplink channel data of the first call connection, and shield the audio data input/output unit in the mobile terminal.

In the GSM and CDMA network standards, for example, the controlling module 10 controls two communication cards of the mobile terminal to respectively establish the first call connection and the second call connection through the GSM and CDMA networks, and upon receiving a call transferring instruction, the processing module 30 takes the downlink channel data received from the GSM network side as uplink channel data of the CDMA network side to transmit, and takes the downlink channel data received from the CDMA network side as uplink channel data of the GSM network side to transmit.

The audio data input/output unit is in the shielded state, that is, it does not perform any data processing, which well protects the privacy of the opposite-end of call transferring. The audio data input/output unit comprises: Mic (Microphone), Receiver, Speaker and other audio data input/output units with the same function.

Preferably, in the call transferring process, when the controlling module 10 receives a call termination instruction sent by the user through the present terminal, the controlling module 10 controls the first communication card and the second communication card to disconnect the established first call connection and second call connection; or the controlling module 10 controls the second call connection of the second communication card to be disconnected when the first call connection of the first communication card is terminated, or the controlling module 10 controls the first call connection of the first communication card to be disconnected when the second call connection is terminated.

In order to facilitate the implementation of the call transferring in the dual-card single-network mode or the dual-card dual-network mode, two sets of baseband radio frequency provided in the embodiment of the present document can process the uplink channel data of the calls respectively established through two communication cards without performing any changes to the network side.

The embodiment of the present document can directly perform a call connection on the opposite-end calls through a call transferring method without hanging up the current call connections when two communication cards respectively establish call connections according to user demands, so as to easily, simply and quickly implement the call transferring function in a mobile terminal.

FIG. 4 shows a functional block diagram of another embodiment of the mobile terminal for transferring a call in a mobile terminal in accordance with an embodiment of the present document. The mobile terminal 2 provided in the present embodiment comprises:

a controlling module 110, configured to: control a first communication card of the mobile terminal to establish a first call connection; and also used to control a second communication card of the mobile terminal to establish a second call connection when receiving a call transferring instruction,

an obtaining module 120, configured to: obtain downlink channel data of the first call connection and the second call connection;
in the present embodiment, the first communication card and the second communication card may belong to the same network standard, which can be any one of GSM, WCDMA, CDMA, TD-SCDMA and LTE, or respectively belong to any two of the GSM, the CDMA, the WCDMA, the TD-SCDMA and the LTE. For example, the controlling module 110 establishes a first call connection through the GSM network standard of the first communication card, and the controlling module 110 establishes a second call connection through the CDMA network standard of the second communication card when receiving a call transferring instruction, or the controlling module 110 establishes the first call connection through the GSM network standard of the first communication card, and the controlling module 110 establishes the second call connection through the GSM network standard of the second communication card when receiving a call transferring instruction.

The controlling module 110 controls the first communication card of the mobile terminal to establish a first call connection; upon receiving a call transferring instruction, the controlling module 110 controls the second communication card of the mobile terminal to establish a second call connection. In this case the controlling module 110 has already established two call connections through the first communication card and the second communication card respectively. The call state corresponding to the first call connection and the call state corresponding to the second call connection are the call activated state, that is, the normal call state.

When the controlling module 110 controls the second communication card of the mobile terminal to establish the second call connection, the obtaining module 120 obtains the downlink channel data of the first call connection established through the first communication card and the downlink channel data of the second call connection established through the second communication card.

A processing module 130 is configured to: take the obtained downlink channel data of the first call connection as the uplink channel data of the second call connection, and take the obtained downlink channel data of the second call connection as the uplink channel data of the first call connection, and shield the audio data input/output unit in the mobile terminal.

In the GSM and CDMA network standards, for example, the controlling module 110 controls its first communication card to establish the first call connection through the GSM network, and the controlling module 110 controls its second communication card to establish the second call connection through the CDMA network, and the obtaining module 120 obtains the downlink channel data of the first call connection established through the first communication card and the downlink channel data of the second call connection established through the second communication card; the processing module 130 takes the downlink channel data received from the GSM network side as uplink channel data of the CDMA network side to transmit, and takes the downlink channel data received from the CDMA network side as uplink channel data of the GSM network side to transmit.

The audio data input/output unit is in the shielded state, that is, it does not perform any data processing, which well protects the privacy of the opposite-end of call transferring. The audio data input/output unit comprises: Mic (Microphone), Receiver, Speaker and other audio data input/output units with the same function.

Preferably, in the call transferring process, when the controlling module 110 receives a call termination instruction sent by the user through the present terminal, the controlling module 110 controls the first communication card and the second communication card to disconnect the established first call connection and second call connection; or the controlling module 10 controls the second call connection of the second communication card to be disconnected when the first call connection of the first communication card is terminated, or the controlling module 10 controls the first call connection of the first communication card to be disconnected when the second call connection is terminated.

In order to facilitate the implementation of the call transferring in the dual-card single-network mode or the dual-card dual-network mode, two sets of baseband radio frequency provided in the embodiment of the present document can process the uplink channel data of the calls respectively established through two communication cards without performing any changes to the network side.

The above description is preferred embodiments of the present document and is not intended to limit the patent scope of the embodiments of the present document, any equivalent structure transformations made by using the contents of the specification and the accompanying drawings of the present document, or directly or indirectly used in other related technical fields, should similarly be included in the patent protection scope of the embodiments of the present document.

### INDUSTRIAL APPLICABILITY

The embodiment of the present document can directly perform a call connection on the opposite-end calls through a call transferring method without hanging up the current call connections when two communication cards respectively establish call connections according to user demands, so as to easily, simply and quickly implement the call transferring function in a mobile terminal.

What is claimed is:

1. A method for transferring a call in a mobile terminal, comprising:
a mobile terminal controlling two communication cards of the mobile terminal to respectively establish a first call connection and a second call connection;
when receiving a call transferring instruction, the mobile terminal obtaining downlink channel data of the first call connection and the second call connection;
the mobile terminal taking the obtained downlink channel data of the first call connection as uplink channel data of the second call connection, and taking the obtained downlink channel data of the second call connection as uplink channel data of the first call connection, and shielding an audio data input/output unit in the mobile terminal.

2. The method of claim 1, wherein, before obtaining the downlink channel data of the first call connection and the second call connection, a call state corresponding to the first call connection is a call hold state, a call state corresponding to the second call connection is a call activated state.

3. The method of claim 1 or 2, wherein, after the mobile terminal controls two communication cards of the mobile terminal to respectively establish the first call connection and the second call connection, the method further comprises:
upon receiving a call termination instruction sent by a user through a present terminal, the mobile terminal controlling two communication cards of the mobile terminal to disconnect the established first call connection and second call connection; or
when the first call connection is terminated, the mobile terminal controlling the second call connection to be disconnected, or when the second call connection is terminated, the mobile terminal controlling the first call connection to be disconnected.

4. A method for transferring a call in a mobile terminal, comprising:
a mobile terminal controlling a first communication card of the mobile terminal to establish a first call connection;
when receiving a call transferring instruction, the mobile terminal controlling a second communication card of the mobile terminal to establish a second call connection and obtaining downlink channel data of the first call connection and the second call connection;
the mobile terminal taking the obtained downlink channel data of the first call connection as uplink data channel of the second call connection, and taking the obtained downlink channel data of the second call connection as uplink channel data of the first call connection, and shielding an audio data input/output unit in the mobile terminal.

5. The method of claim 4, wherein, before obtaining the downlink channel data of the first call connection and the second call connection, a call state corresponding to the first call connection and a call state corresponding to the second call connection are call activated states.

6. The method of claim 4, wherein, after controlling the second communication card of the mobile terminal to establish the second call connection, the method further comprises:
upon receiving a call termination instruction sent by a user through a present terminal, the mobile terminal controlling two communication cards of the mobile terminal to disconnect the established first call connection and second call connection; or
the mobile terminal controlling the second call connection to be disconnected when the first call connection is terminated, or controlling the first call connection to be disconnected when the second call connection is terminated.

7. A mobile terminal for transferring a call in the mobile terminal, comprising:
a controlling module, configured to: control two communication cards of the mobile terminal to respectively establish a first call connection and a second call connection;
an obtaining module, configured to: upon receiving a call transferring instruction, obtain downlink channel data of the first call connection and the second call connection;
a processing module, configured to: take the obtained downlink channel data of the first call connection as uplink channel data of the second call connection, and take the obtained downlink channel data of the second call connection as uplink data channel of the first call connection, and shield an audio data input/output unit in the mobile terminal.

8. The mobile terminal of claim 7, wherein, the controlling module is further configured to:
upon receiving a call termination instruction sent by a user through a present terminal, control two communication cards of the mobile terminal to disconnect the established first call connection and second call connection; or
control the second call connection to be disconnected when the first call connection is terminated, or control the first call connection to be disconnected when the second call connection is terminated.

9. A mobile terminal for transferring a call in the mobile terminal, comprising:
a controlling module, configured to: control a first communication card of the mobile terminal to establish a first call connection; and further configured to: control a second communication card of the mobile terminal to establish a second call connection upon receiving a call transferring instruction;
an obtaining module, configured to: obtain downlink channel data of the first call connection and the second call connection;
a processing module, configured to: take the obtained downlink channel data of the first call connection as uplink channel data of the second call connection, and take the obtained downlink channel data of the second call connection as uplink data channel of the first call connection, and shield an audio data input/output unit in the mobile terminal.

10. The mobile terminal of claim 9, wherein, the controlling module is further configured to:
upon receiving a call termination instruction sent by a user through a present terminal, control two communication cards of the mobile terminal to disconnect the established first call connection and second call connection; or
control the second call connection to be disconnected when the first call connection is terminated, or control the first call connection to be disconnected when the second call connection is terminated.

11. The method of claim 2, wherein, after the mobile terminal controls two communication cards of the mobile terminal to respectively establish the first call connection and the second call connection, the method further comprises:
upon receiving a call termination instruction sent by a user through a present terminal, the mobile terminal controlling two communication cards of the mobile terminal to disconnect the established first call connection and second call connection; or
when the first call connection is terminated, the mobile terminal controlling the second call connection to be disconnected, or when the second call connection is terminated, the mobile terminal controlling the first call connection to be disconnected.

12. The method of claim 5, wherein, after controlling the second communication card of the mobile terminal to establish the second call connection, the method further comprises:
upon receiving a call termination instruction sent by a user through a present terminal, the mobile terminal controlling two communication cards of the mobile terminal to disconnect the established first call connection and second call connection; or
the mobile terminal controlling the second call connection to be disconnected when the first call connection is terminated, or controlling the first call connection to be disconnected when the second call connection is terminated.
